(19) United States
(12) Patent Application Publication
(10) Pub. No.: US 2016/0092901 A1
(43) Pub. Date: Mar. 31, 2016

(54) METHODS AND SYSTEMS FOR CALCULATING AND PROVIDING HOTEL RATE INFORMATION

(71) Applicant: Shirish A. Patel, Mobile, AL (US)

(72) Inventor: Shirish A. Patel, Mobile, AL (US)

(21) Appl. No.: 14/573,295

(22) Filed: Dec. 17, 2014

Related U.S. Application Data
(63) Continuation of application No. 14/541,403, filed on Nov. 14, 2014.
(60) Provisional application No. 62/056,919, filed on Sep. 29, 2014.

(51) Int. Cl. G06Q 30/02; G06Q 10/02; G06Q 50/12

(52) U.S. Cl. CPC G06Q 30/0223; G06Q 50/12; G06Q 10/02

(57) ABSTRACT

A method for determining a hotel rate can include providing a predetermined number of hotel rooms for a predetermined number of nights, and providing a base rate for each of the predetermined rooms. The predetermined number of rooms is multiplied by the predetermined number of nights to yield a room night product, on which a discount is based. The discount is applied to the base rate to determine the hotel rate. Another method of determining a hotel rate can include selecting at least one hotel room for date(s) occurring within a particular week period (week 1) subject to a first base rate, and additional date(s) occurring within another particular week period (week 2) that is subject to a different base rate. The first and second base rates are added together, and the discount is applied to the sum to determine the hotel rate.

### CROSS-REFERENCE TO RELATED APPLICATIONS

This application is a continuation of U.S. application Ser. No. 14/541,403, filed Nov. 14, 2014, which claims priority to U.S. Provisional Patent Application No. 62/056,919, filed Sep. 29, 2014.

### TECHNICAL FIELD AND BACKGROUND OF INVENTION

The present invention relates to the hotel and hospitality industry. One embodiment of the invention comprises a method and system for providing group room rates for hotels and other lodging. Another embodiment of the invention comprises a method and system for providing weekly hotel rates.

There are many Internet websites today that provide information regarding hotel room rates to potential customers. Many such websites purport to offer special discounted rates for hotel rooms, and the competition in this field is robust. As such, there is a need for innovative and efficient methods for calculating and providing rates for hotel rooms and other lodging.

### SUMMARY OF INVENTION

Therefore, one object of the present invention is to provide a method and system for calculating and providing group room rates for hotels and the like. Another object of the present invention is to provide a method and system for calculating and providing weekly room rates for hotels and the like. These and other objectives of the invention can be achieved in various embodiments of the invention described below.

A method for determining a hotel rate according to one embodiment of the invention comprises providing a predetermined number of hotel rooms for a predetermined number of nights, and providing a base rate for each of the predetermined rooms. The predetermined number of rooms is multiplied by the predetermined number of nights to yield a room night product, and a discount is calculated based on the room night product. The discount is applied to the base rate to determine the hotel rate.

According to another embodiment of the invention, the room night product must have a value greater than one in order for the discount to apply.

According to another embodiment of the invention, the discount is calculated by subtracting one from the room night product, and multiplying the difference by a predetermined percentage. This can be expressed as “D=(R−1)×P”, wherein “D” is the discount, “R” is the room night product, and “P” is a predetermined percentage. A computing device can be provided that comprises a computer processor and a non-transitory computer readable storage medium. The computer readable storage medium can comprise software having programming instructions that, when executed, cause the processor to carry out the above described calculation.

According to another embodiment of the invention, the predetermined percentage is at least one percent.

According to another embodiment of the invention, the discount is calculated by multiplying the room night product by the predetermined percentage.

According to another embodiment of the invention, the base rate is a rack rate or a rate of the day.

According to another embodiment of the invention, a hotel reservation for the predetermined number of hotel rooms is provided.

According to another embodiment of the invention, an Internet website is provided, on which a visitor to the website can select the predetermined number of hotel rooms.

According to another embodiment of the invention, the step of providing a predetermined number of hotel rooms for a predetermined number of nights includes providing specific dates.

According to another embodiment of the invention, a system for providing a hotel rate comprises providing means for a potential customer to select a predetermined number of hotel rooms for a predetermined number of nights, and providing at least one base rate for each of the selected hotel rooms. The predetermined number of hotel rooms is multiplied by the predetermined number of nights to yield a room night product, and a discount is calculated based on the room night product. The discount is applied to the base rate to determine the hotel rate. The system can include a computing device comprising a computer processor and a non-transitory computer readable storage medium having programming instructions that, when executed, cause the processor to carry out one or more of the above steps.

According to another embodiment of the invention, the hotel rate is communicated to the potential customer.

According to another embodiment of the invention, the potential customer can make a hotel reservation for the selected predetermined number of hotel rooms for the predetermined number of nights.

According to another embodiment of the invention, a live representative can be provided to communicate with the potential customer and receive the customer's selection of rooms and dates.

According to another embodiment of the invention, an Internet website is provided on which the potential customer can select the predetermined number of hotel rooms for the predetermined number of nights. This information can be transmitted to a computing device comprising a computer processor and a non-transitory computer readable storage medium. The computer readable storage medium can be comprised of software having programming instructions that, when executed, cause the processor to carry out the above described group rate calculation, and the results are displayed on the website for the potential customer.

A method of determining a hotel rate according to another embodiment of the invention comprises selecting at least one hotel room for date(s) occurring within a particular week period (week 1), and additional date(s) occurring within another particular week period (week 2). A base rate is provided for the hotel room during week 1, and a second base rate is provided for the hotel room during week 2. The first base rate and the second base rate are added together to obtain a base rate sum, and the discount is applied to the base rate sum to determine the hotel rate.

According to another embodiment of the invention, at least one date occurring within the first week period and the at least one date occurring within the second week period must total at least seven dates in order for the discount to be applied.

According to another embodiment of the invention, the first and second base rates are standard weekly rates.

According to another embodiment of the invention, an Internet website is provided, on which a visitor to the website selects the hotel room(s) for the date(s) occurring within the first week period, and the date(s) occurring within the second week period.

### DESCRIPTION OF PREFERRED EMBODIMENTS AND BEST MODE OF INVENTION

A preferred embodiment of the present invention comprises a method of calculating hotel group room rates. The term “hotel”, as used throughout this application, refers generally to hotels, motels, and all other types of lodging. The hotel group rate method of this embodiment comprises a process of calculating hotel room rates of groups, which includes multiple room nights as well.

For example, one person purchasing multiple room nights, multiple days in a week, either consecutive or sporadic, is calculated and provided a hotel rate based on the number of room nights. A discount is given based on this exact calculation off of a base rate. “Base rate”, as used throughout this application, refers generally to any standard, undiscounted hotel rate, such as a “rack rate” (also known as “standard rate”), or a “rate of the day” (also known as “today's rate”). Regardless, the discount is based on the number of room nights the customer requires. It can be multiple room nights, or multiple rooms, whichever adds up to categorize as more than one room night. For example, one room multiplied by one room night will be categorized under group policy, however, minimum one room multiplied by two room nights is the minimum to get a discount under the calculator provided as per hotels and their policies.

This is a unique process for the hospitality industry, and has not been digitalized on the world wide web. It can be referred to as “instant group rates”, based on a unique calculator. A discount is calculated off of the number of room nights, with the minimum being one room night.

For example, a hotel can give a discount of 1% for every room/night over one. A customer books a reservation for three rooms for two nights, yielding a total of six room/nights resulting in a discount of 6% off of the rack rate. In another example, a customer books a reservation for two rooms for four nights, yielding a total of eight room/nights resulting in a discount of 8% off of the standard rack rate.

Hotels can have their own strategy for providing discounts to their customers. For example, one to ten room nights or one to ten rooms can start at a discount of any percentage greater than zero, and can increase at the discretion of the hotels.

If an hotelier chooses to have a set value of dollars based off of the number of rooms, they can choose based on dates, including individual dates, multiple dates, season, and/or annual.

According to another preferred embodiment of the invention, the group rate calculation method described above can be utilized on an Internet website. A potential customer visiting the website can enter a desired number of rooms for a desired number of nights. This data is transmitted to a computing device comprising a computer processor and a non-transitory computer readable storage medium. The computer readable storage medium can be comprised of software having programming instructions that, when executed, cause the processor to carry out the above described group rate calculation, and the results are displayed on the website for the potential customer.

Another preferred embodiment of the invention comprises a system for calculating weekly rates for hotel rooms. The system includes a calculator that provides discounts for a minimum of one room for a minimum of seven days, based off of rack rate, rate of the day, standard rate or other individual hotel program. If a customer chooses to look for hotel rooms for a minimum of seven days, then a discount is offered. The discount can start at any percentage greater than zero, and increase at the discretion of the hotelier.

The hotelier can also place a set value per seven days. A calculator can break down rates at weekly to daily if more than one week is involved in the calculation. For example, week 1 costs $700, and week 2 costs $1,400. If the customer chooses to have three days from week 1 and four days from week 2, then the calculator allows prorating on week 1 and prorating on week 2 of the discount due to the fact that the hotelier will choose a minimum of seven days to stay at a particular hotel. Number of rooms is not a factor as one room is the minimum needed to make a reservation for seven days to get a weekly rate.

In another example, a hotel offers a 2% discount for a minimum seven night reservation. The cost for the week of December 12-18 (week 1) is $700 and the cost for the week of December 19-25 (week 2) is $2,100. A person books two nights during week 1 and three nights during week 2. The two nights in week 1 are prorated for a cost of $200 and the 3 nights in week 2 are prorated for a cost of $900, for a total gross cost of $1,100, which is discounted by 2% for a final cost of $1078.

Weekly rate is minimum of seven days, and can extend to many days that are bookable based on availability, rate and inventory provided by the hotelier.

Methods and systems for calculating and providing hotel rate information are described above. Various changes can be made to the invention without departing from its scope. The above description of preferred embodiments and best mode of the invention are provided for the purpose of illustration only and not limitation—the invention being defined by the claims and equivalents thereof.

1: A system for determining a hotel rate comprising a non-transitory computer readable storage medium comprising programming instructions adapted for causing a computer processor to:
(a) receive a predetermined number of hotel rooms for a predetermined number of nights;
(b) receive a base rate for each of the predetermined hotel rooms;
(c) multiplying the predetermined number of hotel rooms by the predetermined number of nights to yield a room night product, wherein the base rate is not used in calculating the room night product;
(d) calculating a discount based on the room night product; and
(e) applying the discount to the at least one base rate to determine the hotel rate.

2: The system according to claim 1, wherein the room night product must have a value greater than one for the discount to apply.

3: The system according to claim 1, wherein the step of calculating the discount comprises executing the expression (R−1)×P, wherein “R” is the room night product, and “P” is a predetermined percentage.

4: The system according to claim 3, wherein the predetermined percentage is greater than zero.

5: The system according to claim 3, wherein the predetermined percentage equals one percent.

6: The system according to claim 1, wherein the step of calculating the discount comprises multiplying the room night product by a predetermined percentage.

7: The system according to claim 1, wherein the at least one base rate comprises one or more selected from the group consisting of a rack rate, and a rate of the day.

8: The system according to claim 1, further comprising the step of providing a hotel reservation for the predetermined number of hotel rooms.

9: The system according to claim 1, further comprising the step of providing an Internet website, wherein a visitor to the website selects the predetermined number of hotel rooms.

10: The system according to claim 1, wherein the step of providing a predetermined number of hotel rooms for a predetermined number of nights includes providing specific dates.

11: A system for providing a hotel rate comprising:
(a) means for a potential customer to select a predetermined number of hotel rooms for a predetermined number of nights;
(b) means for obtaining a base rate for each of the selected hotel rooms;
(c) a computer processor and a non-transitory computer readable storage medium comprising programming instructions causing the computer processor to multiply the predetermined number of hotel rooms with the predetermined number of nights to yield a room night product, wherein the base rate is not used in calculating the room night product, calculating a discount based on the room night product, and applying the discount to the base rate to determine the hotel rate.

12: The system according to claim 11, further comprising the step of communicating the hotel rate to the potential customer.

13: The system according to claim 11, further comprising the step of providing means for the potential customer to make a hotel reservation for the selected predetermined number of hotel rooms for the predetermined number of nights.

14: The system according to claim 11, wherein the step of providing means for a potential customer to select a predetermined number of hotel rooms for a predetermined number of nights comprises providing a live representative to communicate with the potential customer.

15: The system according to claim 11, wherein the step of providing means for a potential customer to select a predetermined number of hotel rooms for a predetermined number of nights comprises providing an Internet website on which the potential customer selects the predetermined number of hotel rooms for the predetermined number of nights.

16: A system for determining a hotel rate comprising a non-transitory computer readable storage medium comprising programming instructions adapted for causing a computer processor to:
(a) receive data comprising a selection of at least one hotel room for at least one date occurring within a first week period, and at least one date occurring within a second week period;
(b) receive a first base rate for the hotel room in the first week period, and a second base rate for the hotel room in the second week period;
(c) add the first base rate and the second base rate together to obtain a base rate sum;
(d) apply a discount to the base rate sum to determine the hotel rate; and
(e) wherein the at least one date occurring within the first week period and the at least one date occurring within the second week period must total at least seven dates in order for the discount to be applied.

17. (canceled)

18: The system according to claim 16, wherein the first base rate comprises a weekly standard rate.

19: The system according to claim 16, further comprising the step of providing a hotel reservation.

20: The system according to claim 16, further comprising the step of providing an Internet website, wherein a visitor to the website selects the at least one hotel room for at least one date occurring within a first week period, and an at least one date occurring within a second week period.
